(19) United States
(12) Patent Application Publication
(10) Pub. No.: US 2005/0097730 A1
(43) Pub. Date: May 12, 2005

(54) Semiconductor manufacturing apparatus

(75) Inventors: Atsushi Yamamoto, Arai-shi (JP); Yoshinori Takamori, Souraku-gun (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Osaka (JP)

(21) Appl. No.: 10/969,056

(22) Filed: Oct. 21, 2004

(30) Foreign Application Priority Data
Nov. 11, 2003 (JP) 2003-380572

(51) Int. Cl. G01M 3/04; B23P 19/00

(52) U.S. Cl. 29/745

(57) ABSTRACT

When inactive gas of which flow rate is controllable is introduced into each processing chamber, the flow rate of the inactive gas is measured by a flow meter, and a computing unit operates computation of the flow rate of the gas to be flown into a processing chamber and the pressure value of the processing chamber, and an appropriate process time (purging time) required for stabilizing the atmosphere/discharging floating foreign particles is set, so that adherence of foreign particles onto the substrate to be processed can be prevented by constantly controlling the time, flow rate and pressure throughout the process.

### BACKGROUND OF THE INVENTION

1. Field of the Invention

The present invention relates to prevention of adherence of foreign particles onto a substrate to be processed in a semiconductor manufacturing apparatus.

2. Description of the Related Art

In semiconductor manufacturing apparatuses, foreign particles adhered onto a substrate to be processed, which are hard to be detected by a foreign particle inspection device depending on the processing, often become the cause of processing failures. Conventionally, the mainstream technology for preventing adherence of foreign particles was to make improvement to the gas introduction section and exhaust position, and to temporarily purge gas during processing.

For example, in a plasma device using high frequency power supply for dry etching and thin film formation, such plasma purging is performed that only the supply of process gas is stopped in one area after plasma etching processing so as to suppress foreign particles generated by transient phenomena which occur when application of RF is stopped, and purging gas is introduced while high frequency voltage is being applied so that floating foreign particles are discharged (e.g. Japanese Patent Application Laid-Open No. H11-274140).

### SUMMARY OF THE INVENTION

It is an object of the present invention to prevent adherence of foreign particles onto a substrate to be processed by constantly controlling time, flow rate and pressure throughout the process.

To achieve the above object, a semiconductor manufacturing apparatus of the present invention comprises: at least one processing chamber processing a semiconductor substrate, comprising a first flow meter for flowing gas while adjusting a flow rate of the gas and a first pressure gauge for measuring pressure inside the chamber; a common transport chamber for transporting the semiconductor substrates to/from the processing chambers, comprising a second flow meter for flowing gas while adjusting a flow rate of the gas and a second pressure gauge for measuring pressure inside the chamber; a load lock chamber connected to the common transport chamber, for transporting the semiconductor substrates to/from the outside, the load lock chamber comprising a third flow meter for flowing gas while adjusting a flow rate of the gas and a third pressure gauge for measuring pressure inside the chamber; and a computing unit for calculating process time based on the gas flow rate and pressure for each chamber, wherein the substrate to be processed is prevented from being adhered with foreign particles, by adjusting the gas flow rate and pressure for each chamber and the calculated process time.

Another semiconductor manufacturing apparatus according to the present invention comprises: a processing chamber for continuously processing a semiconductor substrate, comprising a first flow meter for flowing gas while adjusting a flow rate of the gas and a first pressure gauge for measuring pressure inside the chamber; a load lock chamber connected to the processing chamber, for transporting the semiconductor substrate to/from the outside, the load lock chamber comprising a third flow meter for flowing gas while adjusting a flow rate of the gas and a third pressure gauge for measuring pressure inside the chamber; and a computing unit for calculating process time based on the gas flow rate and pressure for each chamber, wherein the substrate to be processed is prevented from being adhered with foreign particles, by adjusting the gas flow rate and pressure for each chamber and the calculated process time.

The semiconductor manufacturing apparatus is characterized in that the gas flow rate and pressure to be computed by the computing unit are the gas flow rate and pressure measured at the processing chamber.

The semiconductor manufacturing apparatus is also characterized in that the gas flow rate and pressure to be computed by the computing unit are the gas flow rate and pressure measured at the respective processing chamber, common transport chamber and load lock chamber.

The semiconductor manufacturing apparatus is also characterized in that the gas flow rate and pressure to be computed by the computing unit are the gas flow rate and pressure measured at the processing chamber and the load lock chamber.

The semiconductor manufacturing apparatus is also characterized in that the gas is an inactive gas.

The semiconductor manufacturing apparatus is also characterized in that each of the chambers further comprises a pressure control valve, and the computing unit, when calculating the process time, computes an opening degree of the pressure control valve in addition to the gas flow rate and the pressure.

### BRIEF DESCRIPTION OF THE DRAWINGS

FIG. 1 is a schematic diagram depicting a parallel plate plasma CVD device used for depositing a thin film according to the present invention;

FIG. 2 is a schematic diagram depicting a parallel plate plasma CVD device used for depositing a thin film according to Embodiment 1;

FIG. 3 is a diagram depicting the relationship of the flow rate, pressure and time required to discharge foreign particles;

FIG. 4 is a schematic diagram depicting a parallel plate plasma CVD device used for depositing a thin film according to Embodiment 2; and

FIG. 5 is a diagram depicting an image of judgment patterns in the computing unit.

### DESCRIPTION OF THE PREFERRED EMBODIMENTS

Embodiments of the present invention will now be described with reference to the drawings.

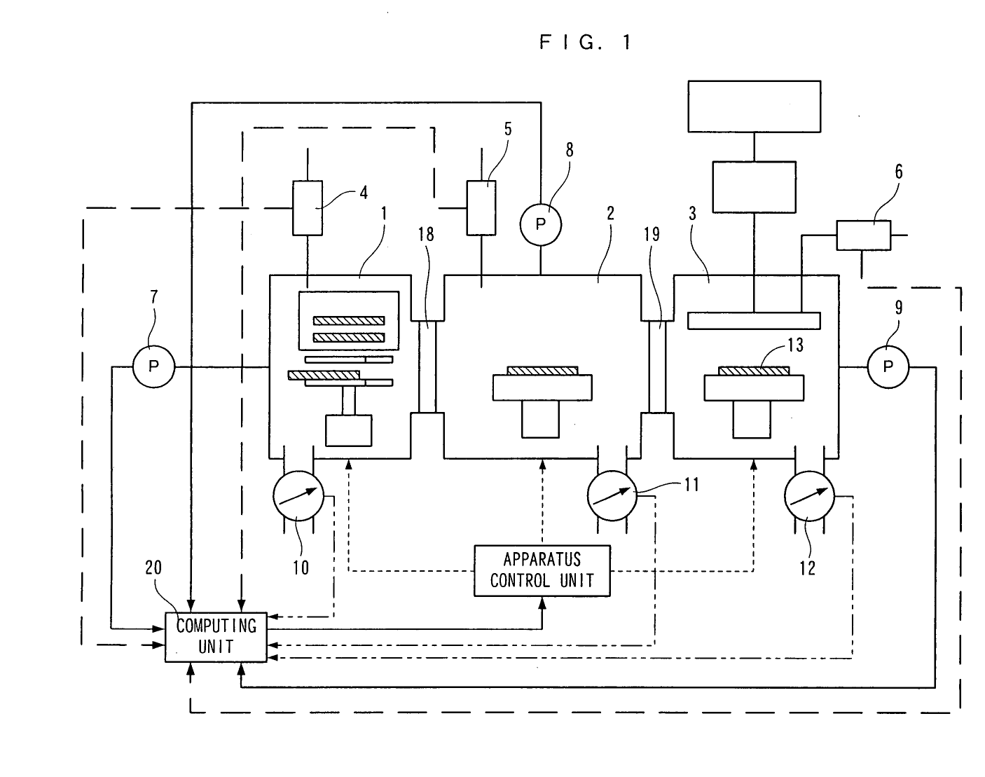

FIG. 1 is a diagram depicting a parallel plate plasma CVD device used for depositing a thin film according to the present invention. This parallel plate plasma CVD device is comprised of a load lock chamber 1, a common transport chamber 2 connected to the load lock chamber 1, and one or more processing chambers 3 connected to the common transport chamber 2. A first gate valve 18 is disposed between the load lock chamber 1 and the common transport chamber 2, and a second gate valve 19 is disposed between the common transport chamber 2 and the processing chamber 3, and each of the gate valves is opened/closed when the substrate is transferred between the chambers. A vacuum pump to maintain the vacuum of each chamber is connected to each chamber via the pressure control valves 10, 11 and 12. A description of these pressure control valves is omitted since it is unnecessary for describing the present invention. In each one of the load lock chamber 1, the common transport chamber 2 and the processing chamber 3, a flow meter 4, 5 or 6, for flowing inactive gas to the chamber while adjusting the gas flow rate, and a pressure gauge 7, 8 or 9, for measuring the pressure inside the chamber, are disposed. The output of the flow rate signals from the flow meter 4, 5 or 6 is branched, and one is connected to input to the control board (not illustrated) of the apparatus, and the other is input to the computing unit 20. For the pressure gauge, one of the outputs is input to the computing unit 20. If there is another output, this output is also connected to the input to the control board (not illustrated) of the apparatus.

The computing unit 20 calculates the process time (atmosphere stabilization time, foreign particle discharging time) based on the output of each flow meter and pressure gauge. In the computing unit, the time required for replacing non-reacted gas and discharging the particles formed by the plasma reaction out of the system is calculated during processing, which frequently changes. The calculated values are reflected in the processing time of the equipment, and the substrate to be processed is moved through the processing chamber after the time required for processing the foreign particles has elapsed from the introduction of the inactive gas, so the substrate to be processed 13 in the processing chamber 3 is processed free from the adherence of foreign particles under optimum time conditions.

Such inactive gas as argon, nitrogen and helium is constantly introduced to each chamber through the flow meter 4, 5 or 6. By this, non-reacted substances and residual gas do not remain on the surface of the substrate to be processed 13, and are discharged by the vacuum pump, which is connected via each pressure control valve. The chamber in which inactive gas is introduced is a viscous flow area, therefore even if the inactive gas and foreign particles are scattered, the average free path thereof is short, backflow from the vacuum pump and the pressure control valve does not occur, and the entry of foreign particles into the chamber is impossible.

In this way, by constantly controlling the time, flow rate and pressure throughout the process, foreign particles existing on the semiconductor device are efficiently discharged, and the adherence of foreign particles onto the substrate to be processed is prevented.

### EMBODIMENT 1

An embodiment of the present invention will be described with reference to the drawings.

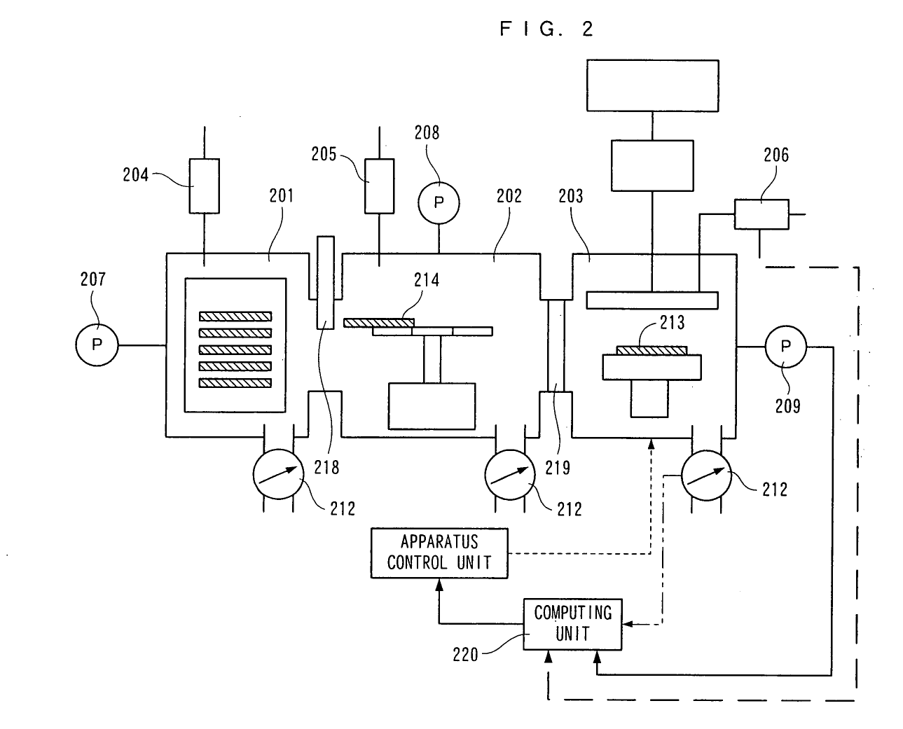

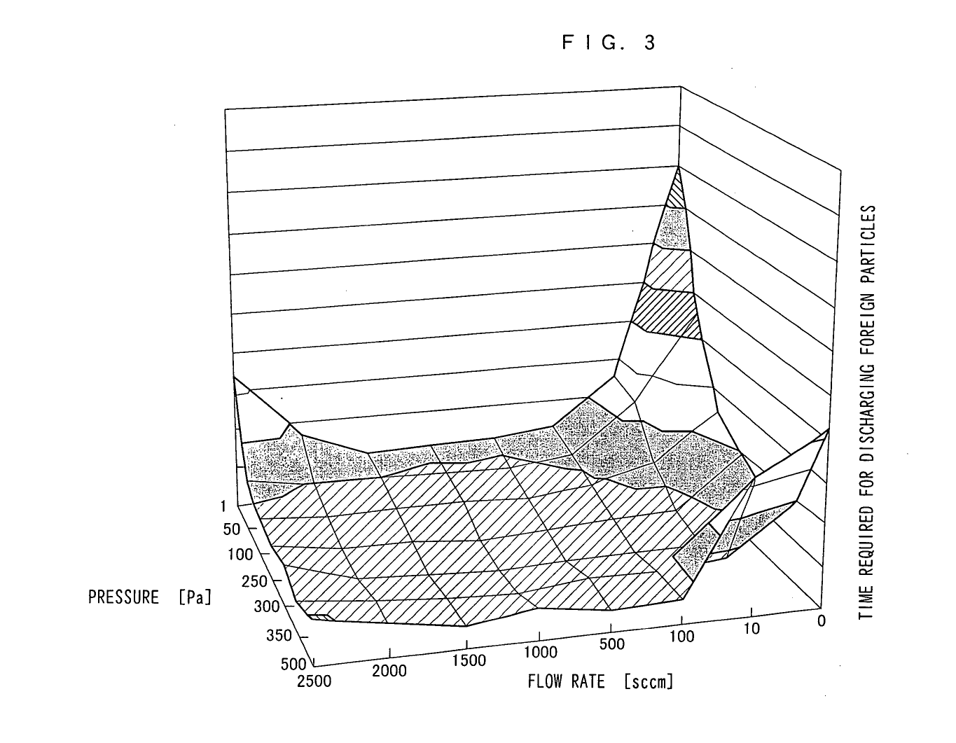

FIG. 2 is a diagram depicting a parallel plate plasma CVD device used for depositing a thin film in Embodiment 1, and FIG. 3 is a diagram depicting the relationship of the flow rate, pressure and time required for discharging foreign particles.

This parallel plate plasma CVD device is comprised of a load lock chamber 201, a common transport chamber 202 connected to the load lock chamber 201, and one or more processing chambers 203 connected to this common transport chamber 202. A first gate valve 218 is disposed between the load lock chamber 201 and the common transport chamber 202, a second gate valve 219 is disposed between the common transport chamber 202 and the processing chamber 203, and each of the gate valves is opened/closed when the semiconductor substrate is transferred between the chambers. A vacuum pump to maintain the vacuum of each chamber is connected to each chamber via the pressure control valve 212. Description on these pressure control valves is omitted since it is unnecessary for describing the present invention. In each of the load lock chamber 201, common transport chamber 202 and processing chamber 203, a flow meter 204, 205 or 206 for flowing inactive gas to the chamber and the pressure gauge 207, 208 or 209, for measuring the pressure inside the chamber are disposed. Standard nitrogen is used as the inactive gas to be flown into each chamber. In the present embodiment, the flow rates of the load lock chamber 201 (standby chamber in this embodiment) and the common transport chamber 202 (transport chamber in this embodiment) are controlled to be 1000 sccm by the flow meter 204, to flow the gas in the chamber. The flow rate of the processing chamber 203 (reaction chamber in this embodiment) is arbitrary. When the substrate to be processed 214 is transported from the load lock chamber 201 to the common transport chamber 202, the flow rate is controlled to be 1000 sccm (the flow rate is the same for each processing chamber) by the flow meter 205 before opening the first gate valve 218, then the flow of inactive gas is started in a direction from inside the substrate to be processed to outside the substrate, when the first gate valve 218 is opened and the substrate to be processed 214 is transported, so as to create a status where foreign particles cannot enter, therefore the number of foreign particles is minimized.

Concerning the pressure of each processing chamber, inactive gas is flowed into the load lock chamber 201 and the common transport chamber 202 via the flow meters 204 and 205, so that the pressure becomes a constant 300 Pa by the pressure gauges 207 and 208. The pressure in the processing chamber 203 is arbitrary. In this case, the number of foreign particles will be minimized if the inactive gas flow rate is adjusted via the flow meters 205 and 206, so that the pressure in the common transport chamber 202 and the processing chamber 203 becomes 266 Pa (the status where no pressure difference exists between chambers) before the second gate valve 219 is opened when the substrate to be processed 213 is transported from the common transport chamber 202 to the processing chamber 203, just like the case of the prior art.

The flow rate of inactive gas to the processing chamber 203 and the pressure in the chamber are input to the computing unit 220, and from these values, an optimum time for discharging foreign particles existing in the processing chamber 203, which may adhered onto the substrate to be processed 213, can be calculated. FIG. 3 shows the result of the time required until the number of foreign particles inside the processing chamber becomes 1 or less at the respective flow rate and pressure measured by a counter, in a status where 0.16 μp or more of foreign particles exists in the processing chamber 203. In terms of flow rate, this time becomes shortest at 1000 sccm, and increases as the flow rate decreases or increases from 1000 sccm, and in terms of pressure, this time becomes shortest at 300 Pa, and increases as the pressure decreases or increases from 300 Pa. By registering this result in the computing unit as a judgment pattern or judgment formula, an optimum foreign particle discharge time under any conditions can be derived. If this result is reflected in the processing step time, the substrate to be processed can be moved in the processing chamber after the time for processing the foreign particles is elapsed from the point when inactive gas was introduced, so that foreign particles do not adhere even if the substrate to be processed is moved in the processing chamber during processing. The time required for discharging foreign particles is derived even at the point of transporting in the chamber, so the transport operation is executed after the derived length of the standby time. Therefore foreign particles do not adhere to the substrate to be processed 213.

As described above, the adherence of foreign particles onto the substrate to be processed can be prevented by constantly controlling the time, flow rate and pressure throughout the process.

In Embodiment 1, the flow rate and pressure, only of the processing chamber 203, are input to the computing unit, but it is preferable that the flow rate and pressure of the load lock chamber 201 and common transport chamber 202 as well are input to the computing unit. Particularly in the case when the common transport chamber 202 and the processing chamber 203 are both reactive chambers and are continuous, the flow rate and pressure values become arbitrary in each chamber, so an optimum time setting by the computing unit becomes more important.

### EMBODIMENT 2

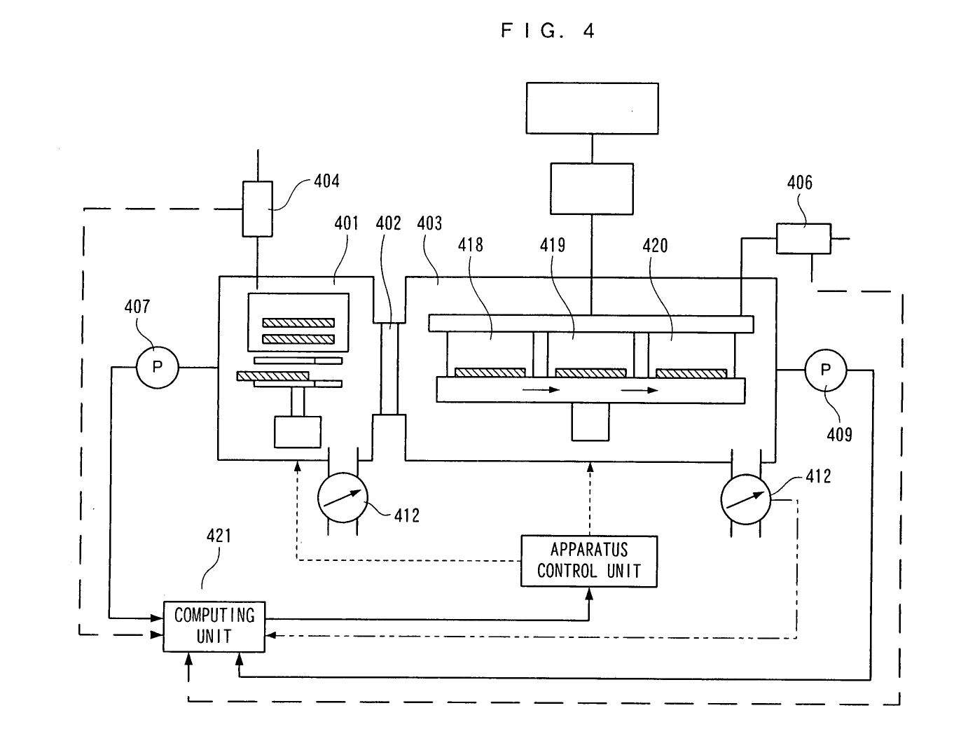

FIG. 4 is a diagram depicting a parallel plate plasma CVD device used for depositing a thin film according to Embodiment 2, where the processing chambers are continuous type processing chambers which allow continuous film deposition, so as to improve productivity. The semiconductor substrates are normally transferred between the load lock chamber and the processing chamber via the common transport chamber, but in Embodiment 2, the common transport chamber, which is not directly required, is omitted. The expected effect is still the same for the apparatus comprising the common transport chamber.

The parallel plate plasma CVD device in FIG. 4 is comprised of a load lock chamber 401, and one or more processing chambers 403 connected to the load lock chamber 401. In the load lock chamber 401 and each of the processing chambers 403, a flow meter 404 or 406 for flowing inactive gas to the chamber and a pressure gauge 407 and 409 for measuring the pressure in the chamber are disposed. The flow rate signal of the flow meter 404 or 406 is branched, and one is input to the computing unit 421 and the other is input to another unit of the apparatus. For the pressure gauge as well, one output is input to the computing unit 421 and the other is input to another unit of the apparatus. This processing chamber 403 is a continuous processing type chamber, so one or more semiconductor substrates can be processed. A first gate valve 402 is disposed between the load lock chamber 401 and the processing chamber 403, which opens/closes when a semiconductor substrate is transferred between the chambers. A vacuum pump to maintain the vacuum in each chamber is connected to each chamber via the pressure control valve 412. In the pressing chamber 403, the desired processing is executed at each stage, which are adjacent to each other. In this embodiment, the process executed at each processing position is the same. When the substrate to be processed, of which processing at the processing position 418 completed, moves to the next processing position 419, the time required for discharging the foreign particles in the processing chamber (corresponding to standby time until movement) is transferred to the apparatus control unit, based on the flow rate and pressure which were input to the computing unit 421. In this embodiment, the flow rate is 1500 sccm and the pressure is 300 Pa, and the time required here is automatically set to five seconds. As soon as this time elapses, that is when the discharge of the foreign particles completes, the substrate to be processed is transported to the next processing position 418 (or from 418 to 419). Since foreign particles have been completely discharged, foreign particles do not adhere onto the substrate to be processed during transport.

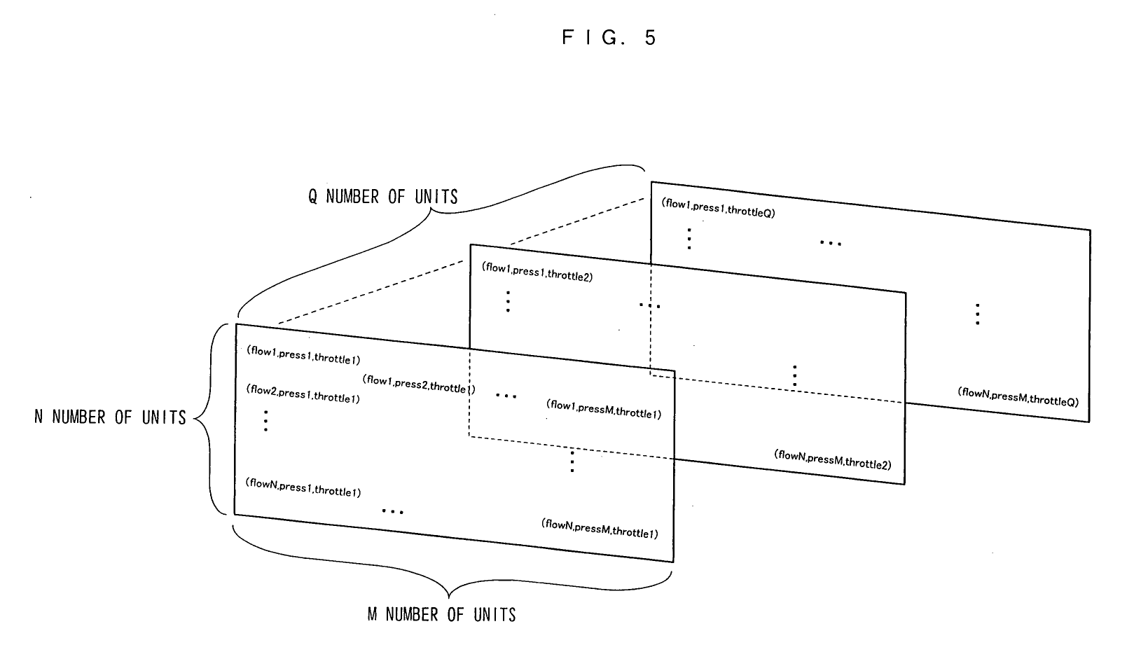

Accuracy further improves if data on the opening degree of the pressure control valve is added in Embodiment 1 and Embodiment 2. For example, when the exhaust performance changes (drops) by a clogging of the pump, the opening degree (opening direction) of the pressure control valve changes accordingly. Using this relationship, the change of the number of foreign particles is registered as a judgment pattern or judgment formula for each pressure control valve position. FIG. 5 shows this image, where the setup time is in the matrix of the flow rate, pressure and opening degree of the pressure control valve, and the time is extracted from the status values of the flow rate, pressure and opening degree of the pressure control valve. In other words, “flow” indicates the flow rate, “pressure” indicates the pressure, and “throttle” indicates the opening degree of the control valve, and (flow, pressure, throttle) correspond to the time required for discharging foreign particles. Since the data on the opening degree of the control valve is added to the content in FIG. 3, and the judgment model is expressed as a parameter, an optimum time can be set using this judgment model. There are N and M sets of data, where the flow and pressure change while fixing throttle, and there are Q sets of data where only the throttle is changed.

In the above description, the parallel plate plasma CVD device was used, but the present invention can be used for various semiconductor manufacturing apparatuses used in the semiconductor industry, such as CVD, PVD and dry etching devices.

1. A semiconductor manufacturing apparatus, comprising:
at least one processing chamber for processing a semiconductor substrate, comprising a first flow meter for flowing gas while adjusting a flow rate of the gas and a first pressure gauge for measuring pressure in the chamber;
a common transport chamber for transporting the semiconductor substrate to/from the processing chamber, comprising a second flow meter for flowing gas while adjusting a flow rate of the gas and a second pressure gauge for measuring pressure in the chamber;
a load lock chamber connected to the common transport chamber, for transporting the semiconductor substrate to/from the outside, the load lock chamber comprising a third flow meter for flowing gas while adjusting a flow rate of the gas and a third pressure gauge for measuring pressure in the chamber; and
a computing unit for calculating process time based on the gas flow rate and pressure for each chamber, wherein
the substrate to be processed is prevented from being adhered with foreign particles, by adjusting the gas flow rate and pressure for each chamber and the calculated process time.

2. A semiconductor manufacturing apparatus, comprising:
a processing chamber for continuously processing a semiconductor substrate, comprising a first flow meter for flowing gas while adjusting a flow rate of the gas and a first pressure gauge for measuring pressure inside the chamber;
a load lock chamber connected to the processing chamber, for transporting the semiconductor substrate to/from the outside, the load lock chamber comprising a third flow meter for flowing gas while adjusting a flow rate of the gas and a third pressure gauge for measuring pressure inside the chamber; and
a computing unit for calculating process time based on the gas flow rate and pressure for each chamber, wherein
the substrate to be processed is prevented from being adhered with foreign particles, by adjusting the gas flow rate and pressure for each chamber and the calculated process time.

3. The semiconductor manufacturing apparatus according to claim 1, wherein the gas flow rate and pressure to be computed by the computing unit are the gas flow rate and pressure measured at the processing chamber.

4. The semiconductor manufacturing apparatus according to claim 1, wherein the gas flow rate and pressure to be computed by the computing unit are the gas flow rate and pressure measured at the processing chamber, the common transport chamber and the load lock chamber.

5. The semiconductor manufacturing apparatus according to claim 2, wherein the gas flow rate and pressure to be computed by the computing unit are the gas flow rate and pressure measured at the processing chamber and the load lock chamber.

6. The semiconductor manufacturing apparatus according to claim 1, wherein the gas is an inactive gas.

7. The semiconductor manufacturing apparatus according to claim 1, wherein each of the chambers further comprises a pressure control valve, and the computing unit, upon calculating the process time, computes an opening degree of the pressure control valve in addition to the gas flow rate and the pressure.
